(19) United States
(12) Patent Application Publication
(10) Pub. No.: US 2017/0049530 A1
(43) Pub. Date: Feb. 23, 2017

(54) FORCE EXERTING ASSEMBLY FOR ORAL IRRIGATING DEVICE

(71) Applicant: WATER PIK, INC., Fort Collins, CO (US)

(72) Inventor: Joseph W. Cacka, Berthoud, CO (US)

(21) Appl. No.: 15/243,797

(22) Filed: Aug. 22, 2016

Related U.S. Application Data
(60) Provisional application No. 62/207,821, filed on Aug. 20, 2015.

(51) Int. Cl. A61C 1/00; A61C 17/02; A61H 13/00

(52) U.S. Cl. CPC A61C 1/0092; A61H 13/005; A61C 17/0202

(57) ABSTRACT

An oral irrigation device including a reservoir, a tip, and a pump. The pump is operative to draw fluid from the reservoir and propel the fluid to the tip. The pump includes a pump body fluidly connected to the reservoir and the tip, the pump body having an interior wall defining a pump chamber, the pump chamber terminating in an open end and a force exerting assembly that is receive within the pump chamber. The force exerting assembly is movable between a first position and a second position and includes a force exerting member and a compressible sealing member received around the force exerting member. The sealing member engages the interior wall of the pump body during movement from the first position to the second position and movement from the second position to the first position to prevent fluids from escaping the open end of the pump body.

### CROSS REFERENCE TO RELATED APPLICATIONS

The present application claims priority to U.S. Provisional Application No. 62/207,821 filed 20 Aug. 2015 entitled “Piston and Seal for Oral Irrigating Device,” the disclosure of which is hereby incorporated by reference in its entirety.

### TECHNICAL FIELD

The present disclosure relates generally to devices for oral irrigation, and specifically to pumps for pumping fluids through oral irrigation devices.

### BACKGROUND

Oral irrigators deliver a high-pressure fluid stream into a user's oral cavity in order to promote oral hygiene and health. Typical oral irrigators use a pump system to transfer fluid from a fluid reservoir through a system of fluid conduits and deliver the fluid to a tip. Typical pump systems use a single member piston molded entirely from plastic positioned within a cylinder of a pump housing to create a one-way seal that facilitates the drawing and expelling of fluid into and out of the pump housing. In order to generate an effective seal between the single member piston and the pump housing, the piston must be precisely designed and manufactured to fit within the pump housing. Minor aberrations in design or manufacture of the piston can result in drops in fluid pressure, reducing the effectiveness of the oral irrigator, or fluid leaks from the pump housing, which may damage other components in the oral irrigator, such as electrical components. Additionally, the configuration of conventional pistons in oral irrigators provide effective seals only in one direction, the pushing direction, introducing inefficiencies and other issues into the device.

The information included in this Background section of the specification, including any references cited herein and any description or discussion thereof, is included for technical reference purposes only and is not to be regarded subject matter by which the scope of the invention as defined in the claims is to be bound.

### SUMMARY

One embodiment of the present disclosure includes an oral irrigation device that includes a reservoir, a tip, and a pump. The pump is operative to draw fluid from the reservoir and propel the fluid to the tip. In some embodiments, the pump includes a pump body having an interior wall defining a pump chamber, the pump chamber terminating in an open end and a force exerting assembly that is receive within the pump chamber. The force exerting assembly is movable between a first position and a second position and includes a force exerting member and a compressible sealing member received around the force exerting member. The sealing member engages the interior wall of the pump body during movement from the first position to the second position and movement from the second position to the first position to prevent fluids from escaping the open end of the pump body.

In another embodiment, a pump assembly for an oral irrigator is disclosed. The pump assembly includes a pump housing and a piston assembly operably connected to the pump housing and movable relative thereto. The pump housing includes a pump inlet in fluid communication with a fluid reservoir, a pump outlet in fluid communication with the pump inlet and a tip for the oral irrigator, and a pump body including an interior surface defining a pump bore, the pump bore positioned between and in fluid communication with the pump inlet and the pump outlet. The piston assembly includes a piston including an end cap, a skirt extending from the end cap, and a sealing groove positioned between the end cap and the skirt, the sealing groove is recessed below an outer surface of the skirt and an outer surface of the end cap. Additionally, the piston assembly includes a dual-direction seal positioned within the sealing groove. The dual direction seal engages the interior wall of the pump body to define one rom ore fluid seals when the piston moves in a first direction in the bore and when the piston moves in a second direction in the bore.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is an isometric view of an exemplary countertop oral irrigator.

FIG. 2 is an isometric view of a handheld oral irrigator.

FIG. 3 is a cross-section view of an exemplary pump that may be used in the oral irrigators of FIGS. 1 and 2.

FIG. 4 is an isometric view of an exemplary sealing member for a force exerting assembly.

FIG. 5 is an isometric view of a force exerting assembly.

FIG. 6 is a side elevation view of the force exerting assembly FIG. 5.

FIG. 7 is a cross-section view of the force exerting assembly of FIG. 5 taken along line 7-7 in FIG. 6.

FIG. 8 is an isometric view of the force exerting assembly of FIG. 5 connected to a drive element.

FIG. 9 is an isometric view of an exemplary pump assembly for a countertop irrigator including the force exerting assembly of FIG. 5.

FIG. 10 is an exemplary cross-section view of a pump incorporating the piston assembly of FIG. 5.

FIG. 11 is an exemplary cross-section view of the pump of FIG. 10 during an intake stroke.

FIG. 12 is an exemplary cross-section view of the pump of FIG. 10 during a compression stroke.

FIG. 13A is a front isometric view of pump assembly for use with the oral irrigators of FIGS. 1 and 2.

FIG. 13B is a rear isometric view of the pump assembly of FIG. 13A.

FIG. 13C is a cross-section view of the pump assembly of FIG. 13A taken along line 13C-13C in FIG. 13A.

FIG. 13D is a cross-section view of the pump assembly of FIG. 13A taken along line 13D-13D in FIG. 13A.

FIG. 14A is a side elevation view of a force exerting assembly for use with the pump assembly of FIG. 13A.

FIG. 14B is a cross-section view of the force exerting assembly of FIG. 14A taken along line 14B-14B in FIG. 14A.

FIG. 15 is a side elevation view of a force exerting member of the force exerting assembly of FIG. 14A.

FIG. 16 is an isometric view of a sealing member of the force exerting assembly of FIG. 14A.

FIGS. 17A-17E illustrate enlarged cross-section views of the pump assembly during various stages of the intake and compression strokes.

### DETAILED DESCRIPTION

Traditional piston designs for pumps for oral irrigation devices result in several limitations and shortcomings. Specifically, traditional single member pistons must be precisely designed and manufactured to fit within a pump body so that the piston engages the interior walls of the pump body sufficient to create a seal to prevent leakage, but must also sufficient to allow movement in the pump body without significant friction that may reduce efficiency of the pump and introduce wear into the system. Further, often the piston material may swell when exposed to fluid, which also must be taken into account during manufacturing. In short, the tolerances for conventional pump systems are extremely small, requiring high precision parts manufactured on expensive and very accurate tools. The expensive tooling and other manufacturing components required to generate these type of conventional piston parts greatly increases the cost of the eventual product and reduces the number of potential manufactures that can create the parts, which also acts to increase the costs of the parts. Further, due to the high precision, the tools have short lifespans as wear within the tool will cause the tolerances to be exceeded. Conventional tooling lifespans for oral irrigator pistons are around two years.

Exemplary implementations of a force exerting assembly for use in an oral irrigation device are disclosed herein that are easier to manufacture than traditional oral irrigator pistons and allows for flexibility when designing, manufacturing, and using the oral irrigator. In one example, the force exerting assembly includes a force exerting element or member, such as a piston, and a compressible sealing member connected thereto. The force exerting member may include a generally cylindrical body defining an interior compartment for receiving a portion of a drive system. A sealing recess is defined towards a top end of the piston and is configured to receive the sealing member. A top end of the force exerting member may form a lip to secure the sealing member in position and is closed to exert a pushing force against fluid within the pump body. In these embodiments, the lip may be beveled along an edge to assist the sealing member being inserted into the sealing recess.

The sealing member is typically a deflectable and/or deformable material, such as urethane rubber, silicone, and/or silicone and may optionally include a low friction additive or coating. In some embodiments, the sealing member may include two or more raised edges or contact areas that engage with the interior surface of the pump body. For example, the sealing member may include two raised ridges or protrusions that extend around the outer surface of the sealing member. In this example, the two raised rings may each engage and be compressed by the interior surface of the pump body, providing a dual seal to prevent fluid from escaping around the piston assembly. The sealing features may be otherwise configured to provide a similar type of seal, while still reducing the surface area engaging the interior walls. The material of the sealing member may be customized to provide a fluid-tight seal against the interior surface of the pump body, but that also reduces the drag on the motor and allows the force exerting member to move relatively freely within the pump body.

In some embodiments, the force exerting member may include a body that is substantially constant in width, such as a cylindrical body, that fits within the pump body without requiring tight tolerances (e.g., tolerances less than 0.002 inches). In particular, the cylindrical body may not engage interior (or substantially engage) the walls of the pump body and may not be used to define a seal for the pump body. In this manner, the force exerting member diameter can fluctuate within a large range of tolerances, allowing easier manufacturing and extending the life of tooling machines that may degrade overtime. The force exerting assembly of the present disclosure allows greater variation in tolerances, and can extend the life of a tooling machine by multiple years (e.g., a range of 4 to 6 years) since the parts will continue to work even though the tolerances may be greater than initially configured. Additionally, the sealing member, which is easily compressed, can adjust for any tolerance errors, ensuring a fluid-tight seal, without the precision required with conventional pistons.

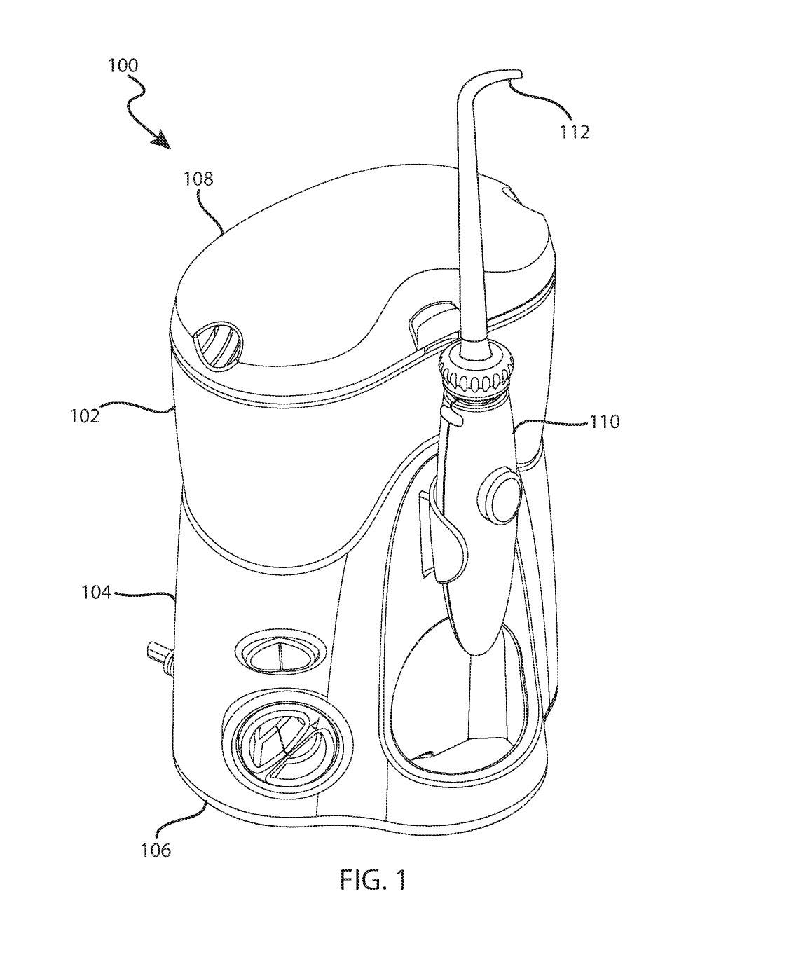

Turning to the figures, the force exerting assembly and oral irrigators including the assembly will now be discussed in more detail. FIG. 1 illustrates an exemplary oral irrigator, generally designated 100, which may include a reservoir 104, a housing 104, a container base 106, a lid 108, a handle 110, and a tip 112.

In various embodiments, the reservoir 104 may store fluid, such as water, and be operably connected to the housing 104, e.g., may be positioned on a top surface of the housing 104. The lid 108 covers all or a substantial portion of the reservoir 104 and is positioned on top thereof in order to prevent spillage or leakage of the fluid contained within the reservoir 104. The housing 104 may support the reservoir 104 and house internal components. The base 106 provides a support structure for internal components as well as the housing 104. The tip 112 may include a nozzle defining an opening for delivering a pressurized fluid stream. The tip 112 may be attached to the handle 110 which may be removably secured to the housing 104 with a clamp. The tip 112 may be fluidly coupled to the reservoir 104 via fluid conduits passing through the handle 110, the housing 104, and one or more internal components. Internal components of the oral irrigator 100 may include a pump 300 or pump assembly for drawing fluid from the reservoir 104 and expelling fluid from the tip 112.

Additional components and controls may be included in the oral irrigator 100. For example, the oral irrigator 100 may include various buttons, knobs, and/or switches for controlling, modifying, starting, and/or stopping fluid flow from the reservoir 104 to the tip 112. Additionally, the oral irrigator 100 may have an internal or external power supply, such as a battery or a power cord connected to a power outlet, a motor for driving the pump system, and/or various fluid connections such as hoses, conduits, and/or tubes. Such components may be integrated into any suitable component of the oral irrigator 100 including the reservoir 104, the housing 104, the container base 106, the lid 108, the handle 110 and/or the tip 112. The oral irrigator 100 may be used by placing the container base 106 on a surface, such as a counter or table, removing the handle 110, with the tip 112 attached thereto, from the housing 104, directing the tip 112 at a desired location, and initiating a fluid stream from the reservoir 104 to the tip 112.

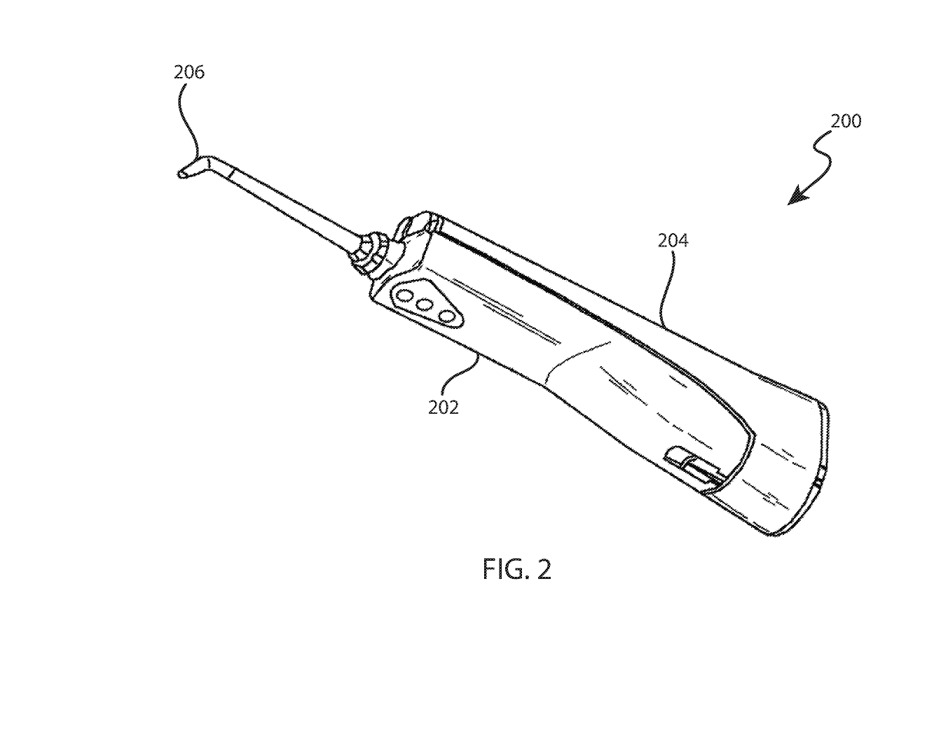

Another example of the oral irrigator is shown in FIG. 2. FIG. 2 illustrates a handheld oral irrigator, generally designated 200, with a tip 206 attached thereto. The oral irrigator 200 includes a body 202, a detachable, refillable reservoir 204 for storing fluid, and a detachable tip 206 for delivering a pressurized stream of fluid to a user's teeth and gums. The body 202 may include one or more interior components, such as a pump 300, for drawing fluid from the reservoir 204 and expelling the fluid from the tip 206. In exemplary embodiments, the reservoir 204 and the tip 206 may be fluidly coupled through the body 202 in order to deliver a continuous, pressurized stream of fluid from the reservoir 204 to the tip 206.

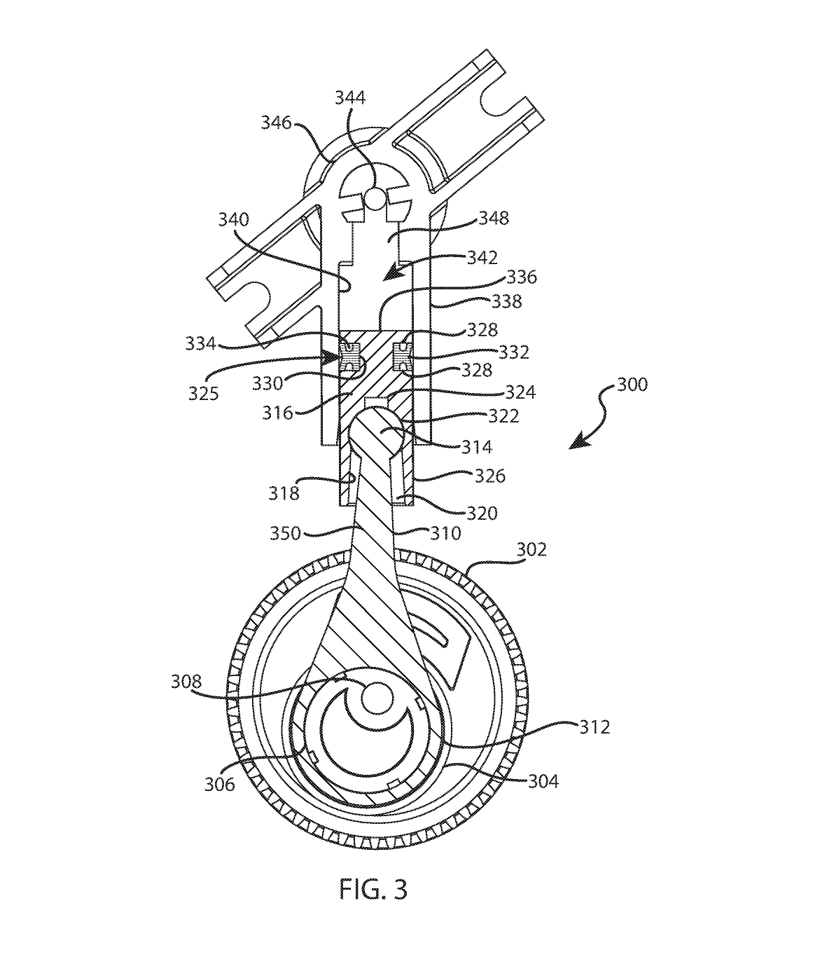

Internal components of the oral irrigator 100 may include a pump or pump assembly for drawing fluid from the reservoir 104 and expelling fluid from the tip 112. With reference to FIGS. 3-12, the pump may include a pump body, a piston assembly, and a pump gear structure. It should be noted that in most embodiments, the pump gear structure is driven by a motor and may be connected directly to the motor or indirectly through a drive assembly having one or more gearing elements. FIG. 3 is a cross-section view of an exemplary implementation of the pump 300 for use in either the countertop oral irrigator 100 of FIG. 1 or the handheld oral irrigator 200 of FIG. 2. The pump 300 generally includes a pump housing 346 with a pump body 338, a piston assembly 332, and a pump gear structure. The piston structure may include a piston body 316, a piston seal 332, and a connecting rod 310 having a hollow connecting portion 312 coupled with an arm 350 terminating in a ball end 314. The pump gear structure may include an outer disc 302, an offset disc 304, an interior offset disc 306, and a gear pin 308.

In various embodiments, the pump housing 346 may include the pump body 338, an interior fluid channel 344, a fluid channel 348, interior cylinder wall 340, and cylindrical chamber 342. The pump body 338 is a structure that defines a space through which a piston head may move in order to draw and expel a fluid. A fluid channel 348, an interior fluid channel 344, and a cylinder chamber 342 may all be fluidly connected spaces, defined by the pump housing 346, which serve as a connected fluid conduit for passing fluid from a reservoir, such as the reservoir 104 and expelling the fluid from an oral irrigator tip, such as the tip 112. In various embodiments, interior cylinder wall 340 is an interior surface within the pump body 338 that defines the shape and dimensions of the cylinder chamber 342. The pump housing 346 may be made from, for example, one or more pieces of molded plastic, metal, or any other suitable material.

As shown in FIGS. 3-7, the piston body 316 may define a hollow portion 320 formed within the piston body 316 with a deeper portion having a curved interior surface 322, and a recess 324. In various embodiments, the piston body 316 may be a single piece of molded plastic of approximately the same size as the cylinder chamber 342. In one exemplary embodiment, the piston body 316 may be substantially cylindrical in shape. The hollow portion 324 may have tapered sidewalls that extend from the curved interior surface 322. In exemplary embodiments, the piston body 316 may include piston wall 326, piston head 336, and an annular recess 325 defined by side walls 328 and a recess bottom 330. The piston seal 322 may be positioned within the annular recess 325. The piston seal 332 may be shaped as a double U-cup seal, quad ring, or the like.

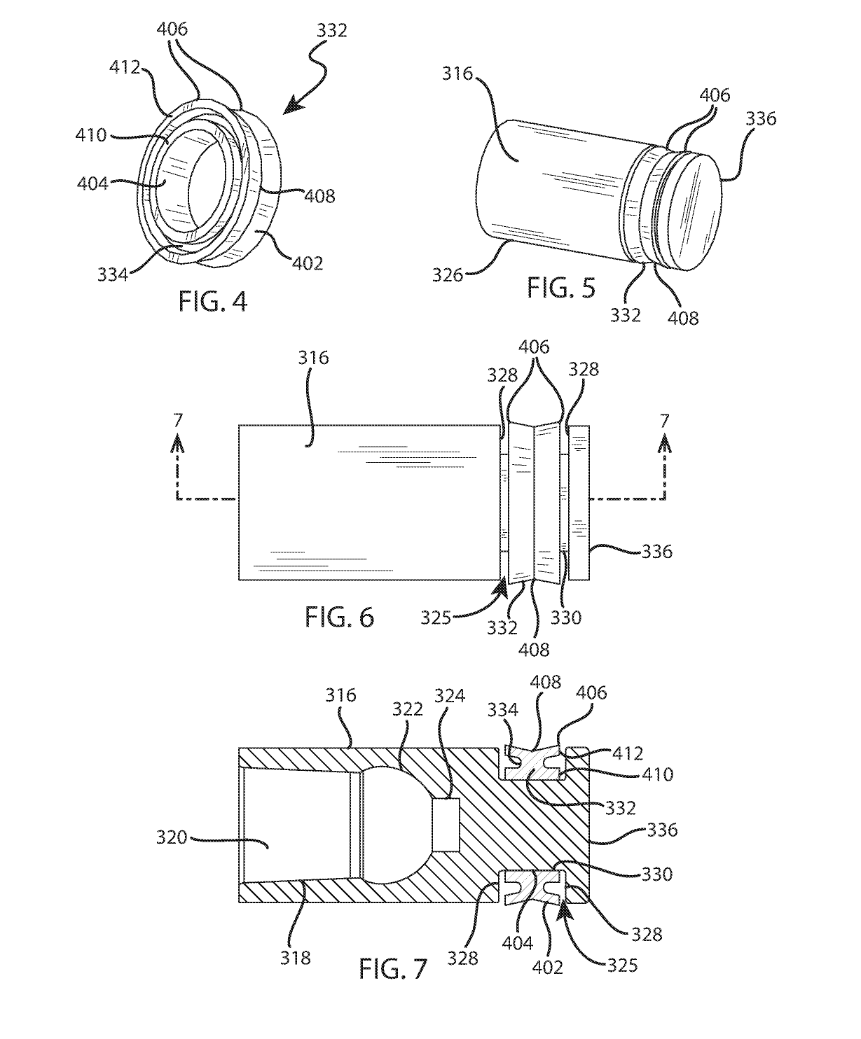

FIG. 4 is an isometric view of an exemplary the piston seal. The piston seal 322 may be formed of any suitable material to generate a fluid tight seal with the interior cylinder wall 340, such as flexible rubber, plastic, silicon, elastomeric materials, or other polymers. The piston seal 332 may have an inner surface 404 for contacting the recess bottom 330, two side walls 410, 412 having inwardly extending annular grooves 334, and an outer concave surface 402 with a vertex 408 at approximately at the center of the outer concave surface 402 and two contact edges 406. The contact edges 406 may occur at locations where the outer surface 402 meets the outer side wall 412. The contact edges 406 may form a fluid seal when contacting the interior cylinder wall 340. The piston seal 332 may be positioned within the annular recess 325 of the piston body 316 defined by the side walls 328 and the recess bottom 330. As discussed in further detail below, the contact edges of the piston seal 332 may at least partially extend radially beyond the piston wall 326 to form a fluid seal with the interior cylinder wall 340.

Returning again to FIG. 3, the outer disc 302 may be a gear driven by a drive mechanism, such as a motor powered by a battery or an external power cord. The gear pin 308 defines a central axis about which the outer disc 302 rotates when driven by the drive mechanism. As shown in FIG. 3, the center of the offset disc 304 may be offset from the central axis defined by the gear pin 308. The amount of offset may vary depending upon the desired performance of the pump. The interior offset disc 306 may be attached to the offset disc 304 and centered about the same axis as the offset disc 304. Interior offset disc may further include a hole formed near the edge thereof through which the gear pin 308 may pass. The interior offset disc 306 may be free to revolve about the gear pin 308.

The pump gear structure and the piston structure may function in concert to move the piston body 316 within the pump body 338. In exemplary embodiments, the hollow cylinder portion 312 of the connecting rod 310 may be rotatably positioned around the interior offset disc 306. In such embodiments, when the outer disc 302 rotates about the axis defined by the gear pin 308, the interior offset disc 306 revolves about the gear pin 308. In such embodiments, the hollow cylinder portion 312, which encases the interior offset disc 306, translates the rotational motion of the interior offset disc 306 into linear motion of the piston body 316. In order to facilitate the linear motion of the piston body 316, ball end 314 may be pivotably positioned within the curved interior surface 322 of the recess 324. The motion of the hollow cylinder portion 312 about the axis defined by the gear pin 308 may result in some lateral motion of the arm 350. In order to accommodate the lateral motion of the arm 350, the hollow portion 320 may be formed large enough within the piston body 316, and defined by the tapered inner wall 318, to allow clearance for lateral motion of the arm 350 during reciprocal motion of the pump structure. FIGS. 5 and 6 are an isometric view and a side elevation view, respectively, of an exemplary piston body 316 and piston seal 322, in accordance with the embodiment of FIG. 3.

FIG. 7 illustrates a cross-section view of piston head 316 with the piston seal 332. As shown in FIG. 7, the piston seal 332 may be positioned within the annular recess 325 of the piston body 316 defined by the side walls 328 and the recess bottom 330. The inner surface 404 of the piston seal 332 may abut the recess bottom 330. The recess bottom 330 and the piston seal 332 may each have a width associated with them. In one exemplary embodiment, the width of the piston seal 332 is substantially the same as the width of the recess bottom 330. In another exemplary embodiment, the width of the recess bottom 330 may be greater than the width of the piston seal 332. In such an embodiment, outer side walls 412 may be free to flex toward inner side walls 410 under a force from interior cylinder wall 340. Such flexing of outer side wall 412 of the piston seal 332 may facilitate an improved seal with interior cylinder wall 340 by increasing the surface area of contact edges 406.

The annular recess 325 may also have a depth associated with it defined by the side walls 328. Similarly, the piston seal 332 may have an outer depth associated with it defined by the distance between the inner surface 404 and the contact edges 406. In various embodiments, contact edges 406 may extend radially past the depth of the side walls 328 in order to contact the interior cylinder wall 340 and create a fluid seal. In further embodiments, the piston seal 322 may have an interior depth associated with it defined by the distance between the inner surface 404 and the vertex 408. In some embodiments, the interior depth of the piston seal 332 may be less than the depth of the side walls 328. In embodiments, where the outer depth is greater than the depth of the side walls 328 and the interior depth is less than the depth of the side walls 328, outer side walls 412 may flex toward inner side walls 410 to increase the contact area of the contact edges 406 and improve the quality of seal with the interior cylinder wall 340.

FIG. 7 further shows that the annular recess 325 may be formed substantially toward one end of the piston body 316 adjacent to piston head 336. As mentioned above, placement of the annular recess 325 toward one end increases the displacement through which the piston body 316 may move while maintaining a seal with the interior cylinder wall 340. Additionally, placement of the annular recess 325 toward the end of the piston body 316 ensures that the piston body 316 contains sufficient volume to form the recess 324, curved the interior surface 322, and the hollow portion 320 to receive the ball end 314 of the connecting rod 310.

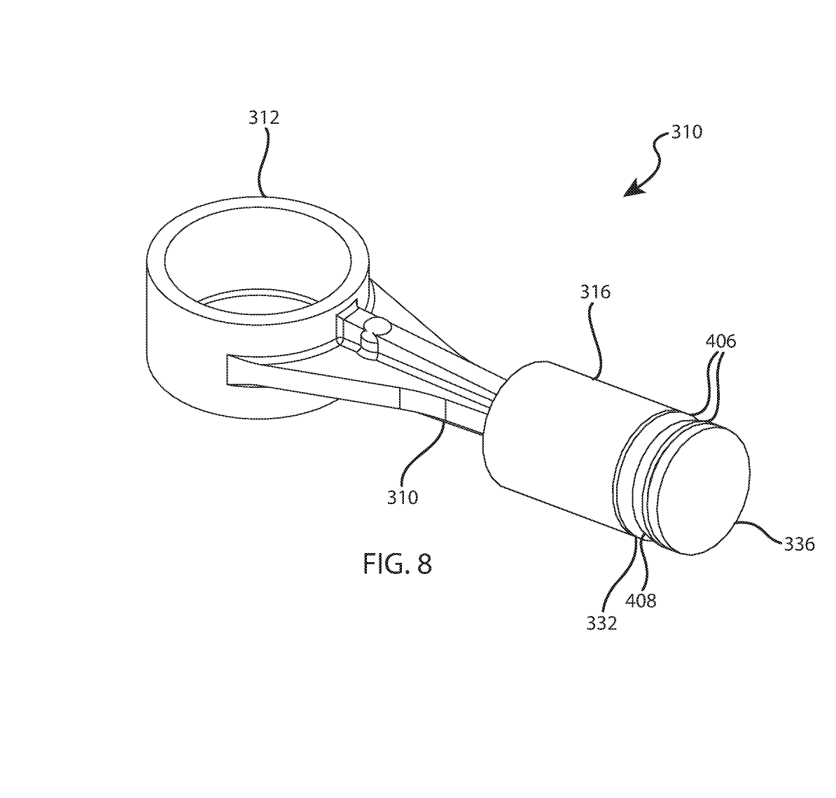

FIG. 8 is an isometric view of a piston structure including the piston body with the double-faced U-cup seal of FIG. 5. The arm 310 may fit into the hollow portion 320 so that the ball end 314 fits into the recess 324 and contacts curved the interior surface 322. The piston body 316 may be substantially cylindrical so as to slidably fit within cylindrical chamber 342. The piston head 336 may also be substantially round and create a flat platform for propelling fluid within cylindrical chamber 342.

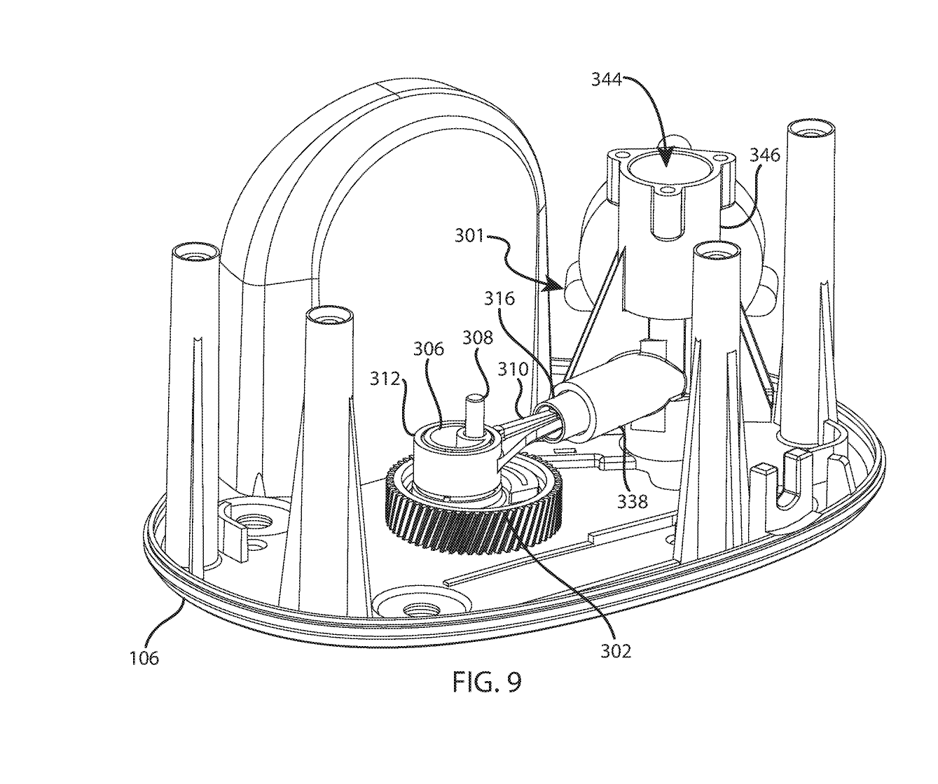

FIG. 9 is an isometric view of an exemplary pump assembly 301 for the table top oral irrigator 100 of FIG. 1 with the housing thereof removed. The pump housing 346 may be placed substantially vertically so that the fluid channel 344 draws fluid from the reservoir 104 positioned above the pump housing 346. The pump body 338 may extend at approximately a ninety degree angle from the pump housing 346 to receive the piston body 316. As discussed above, the outer disc 302 may be driven by a drive mechanism, such as a motor (not shown), to rotate about the gear pin 308. The interior offset disc 306, which is fixed to the outer disc 302, may revolve around the gear pin 308. The hollow cylinder portion 312 slidably contacts the interior offset disc 306 such that as the interior offset disc 306 revolves, the hollow cylinder portion 312 revolves about the gear pin 308 but maintains its approximate orientation with respect to the pump housing 346. As such, the rotation of the outer disc 302 drives arm 310 and the piston body 316 toward and away from the pump body 346 within the pump body 338 during the up stroke and down stroke of the pump assembly 301, respectively.

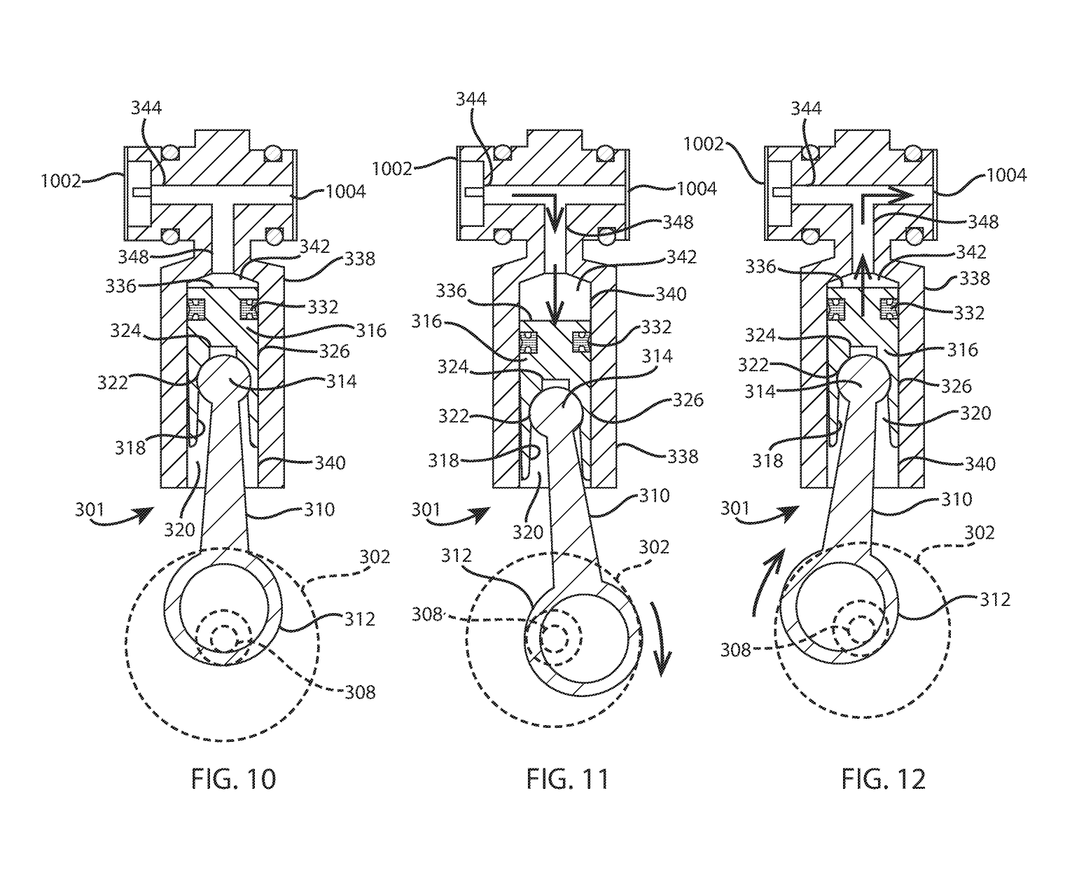

FIGS. 10-12 demonstrate the functioning of the exemplary pump assembly 301 of FIG. 9 during a complete cycle of the piston through an up stroke and a down stroke. Referring now to FIG. 10, the pump assembly 301 is depicted at the top of an up stroke of the piston body 316. The pump system of FIG. 10 includes an inlet port 1002 and an outlet port 1004. In various embodiments, the inlet port 1002 may be fluidly connected to a fluid reservoir, such as the reservoir 104 or 204, and the interior fluid channel 344. The inlet port 1002 may further include a reed valve that acts as a check valve to allow fluid to flow in only one direction. For example, in the embodiment of FIG. 10, fluid may only flow through the inlet port 1002 in a direction from the attached reservoir into the interior fluid channel 344. Similarly, the outlet port 1004 may be fluidly attached to a fluid conduit terminating in a tip, such as tips 112 or 206. The outlet port 1004 may include a single direction reed valve permitting fluid to flow only in a direction from the interior fluid channel 344 to the attached tip. The interior fluid channel 344 may be fluidly connected to the cylinder chamber 342 via the fluid channel 348.

FIG. 11 depicts the pump assembly 301 of FIG. 9 during a down stroke, or intake stroke. As the outer disc 302 and the gear pin 308 rotate, the hollow cylinder portion 312 of the connecting rod 310 may move around the gear pin 308 pulling the connecting rod 310 downward and to one side of the hollow portion 320, drawing the connecting rod 310 and the piston body 316 away from the fluid channel 348, and increasing the volume of the cylinder chamber 342. In various embodiments, the piston seal 332 maintains contact with the interior cylinder wall 340 and creates a fluid seal so as to prevent fluid from escaping the pump body 338 throughout the down stroke depicted in FIG. 11. As the piston head 336 moves away from the fluid channel 348, a vacuum force may be created in the cylinder chamber 342 which draws fluid into the cylinder chamber 342 through the inlet port 1002, which is fluidly connected to a fluid reservoir, such as reservoir 104 or 204.

FIG. 12 depicts the pump assembly 301 of FIG. 10 during an up stroke, or compression stroke. In the depicted embodiment, the outer disc 302 completes the rotation of FIG. 11. The rotation of the outer disc 302 may push hollow cylindrical portion 312 of the connecting rod 310 upward and toward the opposite side of the hollow portion 320 and thus push the piston body 316 toward the fluid channel 348. Piston head 336, in combination with the piston seal 332, may compress fluid pulled into the cylinder chamber 342 during the intake stroke of FIG. 11 until the compression is sufficient to force the fluid through the outlet port 1004 and toward a tip, such as the tip 112 or 206. During each cycle of the pump assembly 310 as depicted in FIGS. 10-12, the piston seal 332 may maintain at least two annular contact edges with the interior cylinder wall 340 at each of the contact edges 406 (see FIGS. 4-7). By providing multiple contact edges 406 between the piston seal 332 and the interior cylinder wall 340, the pump assembly 406 may provide an improved seal against leakage of fluid out of the pump body 338 as well as providing an easier to manufacture pump structure.

### ADDITIONAL EXAMPLES

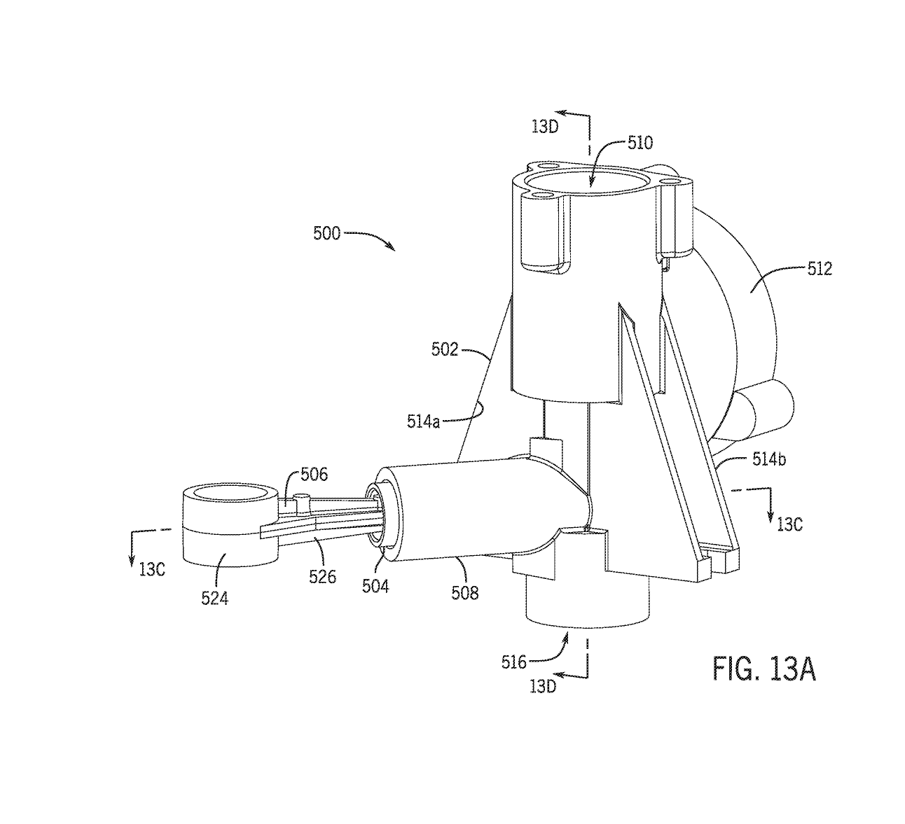

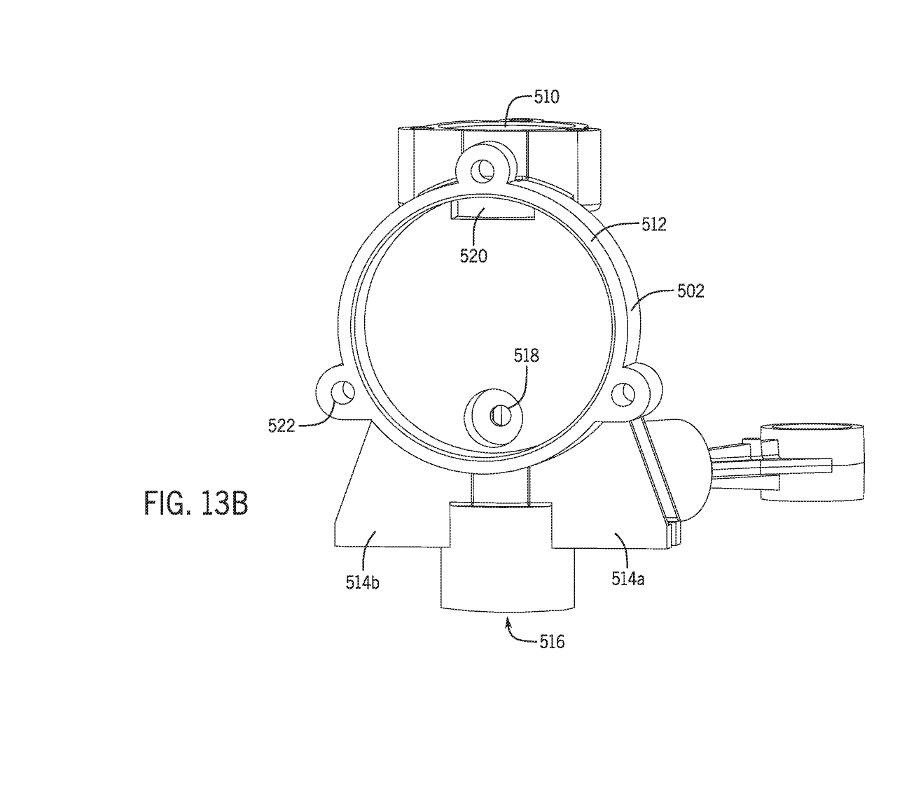

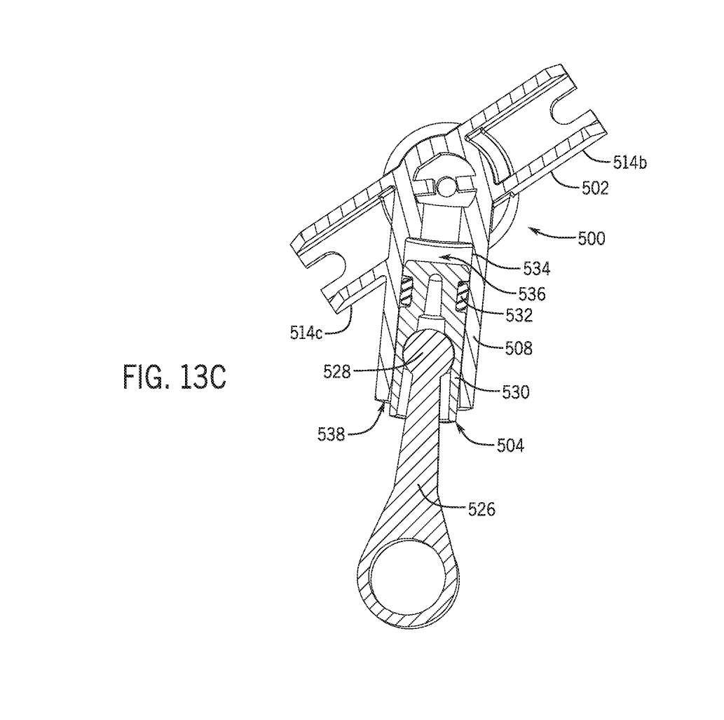

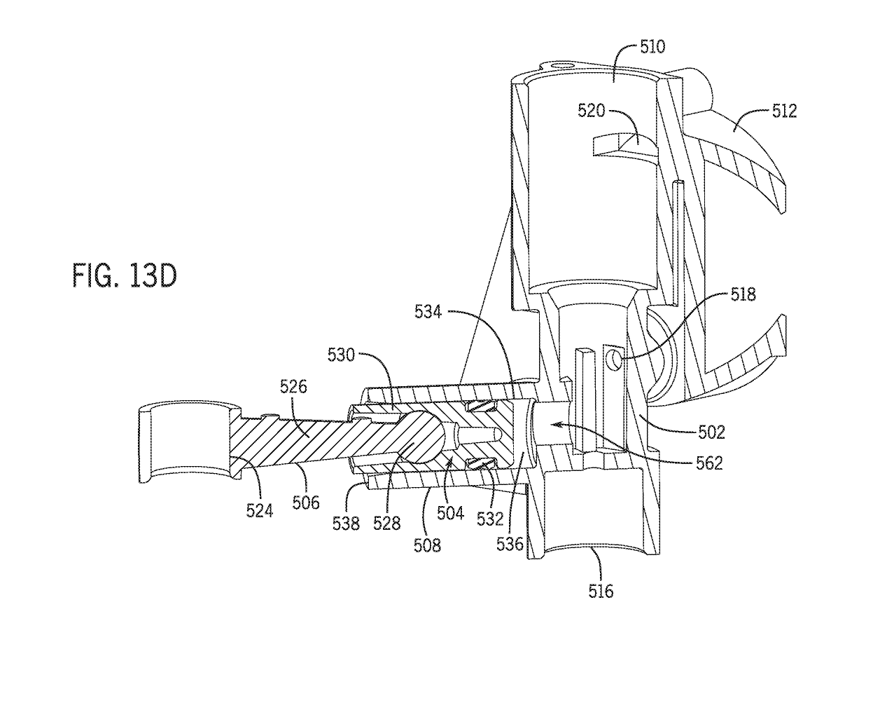

Additional examples of the pump and force exerting assembly for use with the oral irrigators 100, 200 shown in FIGS. 1 and 2 will now be discussed. FIGS. 13A-16 illustrate various views of another example of the pump and force exerting assembly. With reference initially to FIGS. 13A-13D, the pump assembly 500 may include a pump housing 502, a force exerting assembly 504, such as a piston assembly, and a connecting rod 506. The pump housing 502 defines a fluid pathway from the reservoir 102 to the tip 112 and the piston assembly 504 and connecting rod 506 act together to pump fluid from the reservoir 102 to the tip 112. Each of the elements of the pump assembly 500 will be discussed, in turn, below.

The pump housing 504 includes a pump inlet 510, a pump outlet 516, and a pump body 508 that at least partially receives the piston assembly 504 and connecting rod 506. The pump inlet 510 and pump outlet 516 are both in fluid communication with the pump body 508 and in some embodiments, the pump body 508 includes a body lumen 562 positioned between the pump inlet 510 and the pump outlet 516. The pump inlet 510 and pump outlet 516 each may be configured to receive valves. For example, the pump inlet 510 may be configured to receive a backflow valve to prevent backflow from the pump into the reservoir 104. As another example, a one way valve, such as a reed valve, may be positioned in in the pump outlet 516 to allow flow only in one direction, e.g., out of the pump housing 502 and towards the handle 110.

In some embodiments, the pump housing 504 may include a regulator housing 512 extending from a first side of the pump housing 502. The regulator housing 512 may be configured to receive a pressure relator or pressure valve that acts to reduce the pressure of the fluid exiting the pump assembly 500. An example of the regulator may be found in U.S. Pat. No. 8,408,483 entitled “Adjustable Flow Regulator for Dental Water Jet,” granted on April 2, 2013 and incorporated by reference herein in its entirety. In one example, the regulator assembly may be formed as a bypass valve that redirects fluid exiting the pump chamber 536 through the body lumen 562 back to the pump inlet 510 and into the reservoir 104. As shown in FIG. 13B, in this example, the regulator housing 512 may define a regulator inlet 518 and a regulator outlet 520, where the regulator inlet 518 receives fluid from the body lumen 562 and directs the fluid to the regulator outlet 520 which then directs the fluid into the pump inlet 510 where it may return to the reservoir 104.

The pump housing 502 may also include one or more securing features, such as securing brackets 514a, 514b and fastening elements 522. The position and structure of the securing brackets 514a, 514b and fastening elements 522 may be varied based on the structure of the housing for the oral irrigator, but generally they are configured to secure the pump housing 502 to a base or the housing.

With reference to FIGS. 13A, 13C, and 13D, the pump body 508 extends outwards from the pump housing 502 and in some embodiments may extend at an angle relative to the pump housing 502. The pump body 508 may be defined as a cylindrical housing and is shaped and dimensioned so as to receive the piston assembly 504. The pump body 508 extends from and connects to the pump housing 502 and includes an end wall 535 at a first end that defines the body lumen 562 therethrough. The body lumen 562 is in fluid communication with the pump inlet 510 and the pump outlet 516. The pump body 508 also defines a pump chamber 536 that extends a length of the pump body 508 and terminates at a terminal open end 538 of the pump body 508. The pump chamber 536 or bore is in fluid communication with the body lumen 562 and thus in fluid communication with the pump inlet 510 and pump outlet 516. The pump chamber 536 is defined by an interior wall 534 forming an interior sidewall for the pump body 508 and an end wall 535. In one embodiment, the pump chamber 536 has a constant or substantially constant width or diameter along a substantial portion of its length. In some embodiments, however, the pump chamber 536 may angle outwards right before the open end 538 in order to allow easier assembly of the piston assembly 504 into the pump chamber 536 as discussed in more detail below.

With reference to FIGS. 13A-13D, the connecting rod 506 or crank shaft is substantially similar to the connecting rod 310 and may connect to a drive assembly or other drive element in a similar manner as described with respect to the connecting rod 310. In particular, the connecting rod 506 may connect directly or indirectly to a motor that causes the connecting rod 506 to move as described in U.S. Pat. No. 7,147,468 entitled “Handheld Oral Irrigator” granted on Dec. 12, 2006 and incorporated by reference herein in its entirety. The motion of the connecting rod 506 causes the piston assembly 504 to move within the pump chamber 536 as will be discussed in more detail below.

In one embodiment, the connecting rod 506 includes a cam follower 524 configured to engage with a drive assembly, such as an cam surface connected to a pump gear. The cam follower 524 may be defined as a ring or cylindrical body that may be positioned over a gear (see e.g., FIG. 9), but can be otherwise configured depending on a connection to the drive assembly. An arm 526 extends from a top surface of the cam follower 524 and may be formed as a triangularly shaped protrusion that terminates in a connecting end 528. The connecting end 528 defines a terminal end of the connecting rod 506 and is configured to securely connect to the piston assembly 504 in order to drive the piston assembly 504. For example, in one embodiment the connecting end 528 defines a ball or spherical shaped end that snaps into a corresponding groove or cavity defined in the piston assembly 504.

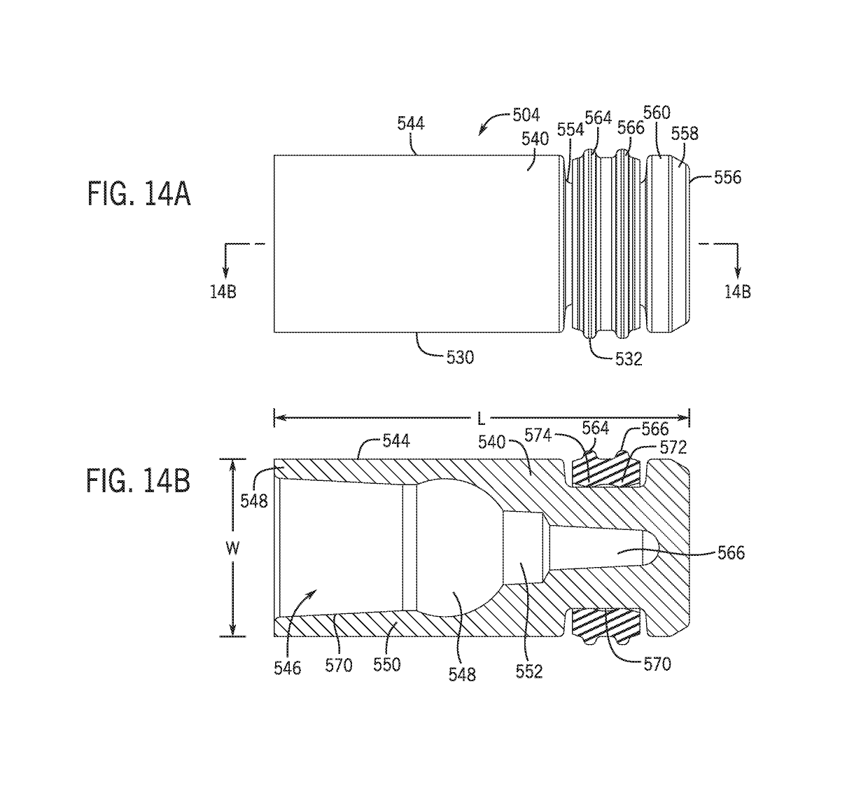

The piston assembly 504 will now be discussed in more detail. FIG. 14A illustrates a side elevation view of the piston assembly 504. FIG. 14B is a cross-section view of the piston assembly of FIG. 14A taken along line 14B-14B in FIG. 14A. The piston assembly 504 is driven by a pump (e.g., via the connecting rod 506) in order to alternatingly pull fluid from the reservoir 104 and push the fluid to the tip 112. The piston assembly 504 includes a force exerting member, such as a piston 530, and a sealing member 532 connected thereto, each discussed in turn below.

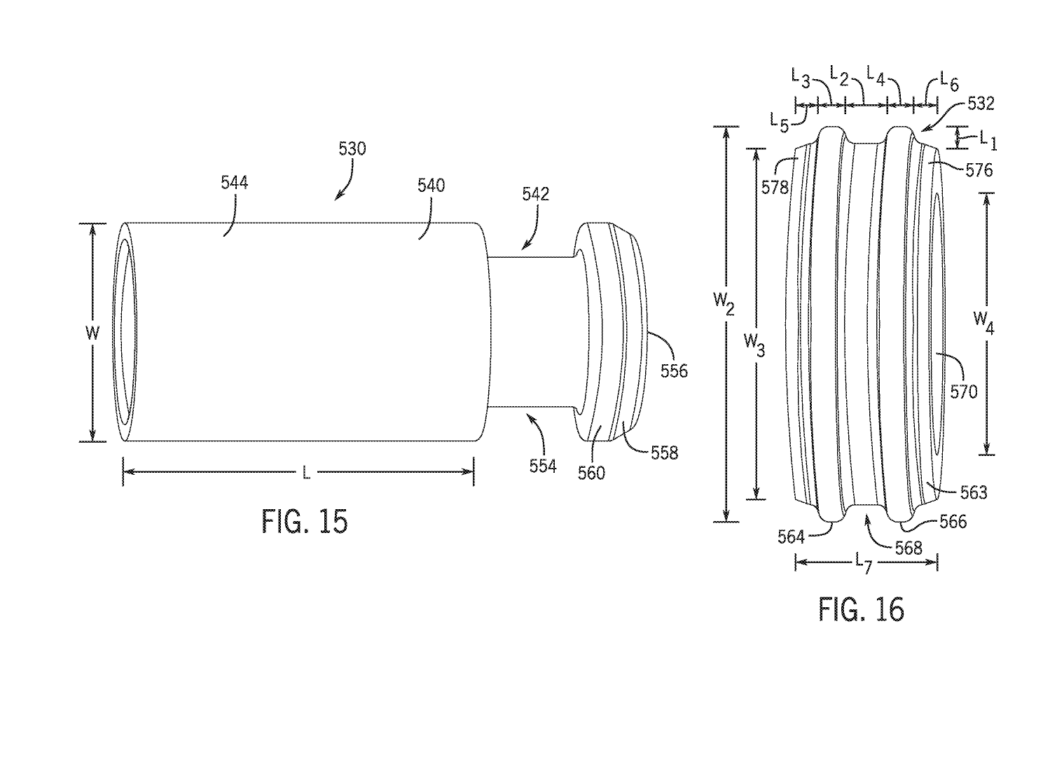

The piston 530 is a body connected to and moved by a drive assembly to exert a force onto a fluid and create a vacuum to pull in fluid. FIG. 15 illustrates a side elevation view of the piston 530. With reference to FIGS. 14A-15, the piston 530 includes a main body 540 that defines a skirt and a sealing end 542 extending from a first end of the main body 540. The main body 540 includes sidewalls 550 having an outer surface 544 and an interior surface 563. The main body sidewalls 550 may be configured such that a width W1 of the main body 540 remains constant along the length L1 of the main body 540. In other words, the outer diameter of the main body 540 of the piston 530 may remain consistent, not taper, along its length. The constant width of the main body 540 provides enhanced stability in the pump chamber 536 and helps to ensure that the piston 530 remains aligned within the pump chamber 536, especially in instances where the connecting rod 506 may be driven by an eccentric and the piston 530 may be under forces to move in a partially non-linear motion within the pump chamber 536. Conventional pistons in oral irrigators were required to have expanding body shapes in order to help ensure a fluid-tight connection within the pump chamber. With the piston assembly 504, the sealing member 532 provides a fluid seal, allowing the piston body to be shaped as shown in FIGS. 14A-15, helping to maintain an alignment of the piston within the pump chamber and allowing less stringent manufacturing tolerances.

A connection cavity 546 is defined by the sidewalls 550 and may vary in dimension along the length L1 of the main body 540 and may extend into the sealing end 542 of the piston 530. To vary the diameter of the connection cavity 546, the thickness and configuration of the interior walls 534 varies such that the connection cavity 546 tapers and then expands into a concave shape to define a ball cavity 548 for connecting to the terminal end of the connecting rod 506. In one example, the connection cavity 546 has a width of approximately 0.213 (±0.003 inches) and the width slightly widens right before the terminal edge 548 of the piston 530. Additionally, the ball cavity 548 has a diameter that is larger, in one example 0.233 (±0.002). The variation in width between the connection cavity 546 and ball cavity 548, as well as the thin sidewalls 550, allow the piston 530 to flex and deform around and secure to the connecting rod 506 as discussed below.

After the ball cavity 548 the connecting cavity 546 continues to taper, defining an end cavity 552 having a smaller diameter and thicker sidewalls 550 as compared to the ball cavity 547. A nose cavity 566 extends from the end cavity 552 and extends into the sealing end 542 of the piston 530.

With reference to FIG. 15, the sealing end 542 defines a top end or portion of the piston 530. The sealing end 542 includes a varying width for the piston 530 and in particular a sealing recess 554 is defined on the sealing end 542. In some embodiments, the sealing recess 554 is defined as an annular recess that extend around the entire outer surface of the sealing end 542. The configuration of the sealing recess 554 may be varied based on changes to the sealing member 532. The sealing recess 554 has a reduced height as compared to the main body 540 and in one example may have a width of approximately 0.205 (±0.003) inches and a length of approximately 0.134 inches.

The sealing recess 554 is bounded on a first end by the terminal edge of the main body 540 and on a second end by a lip 560. In some embodiments, the lip 560 has the same width or diameter of the main body 540.

From the lip 560, the sealing end 542 transitions to define a beveled surface 558 positioned between the lip 560 and the end cap 556. The beveled surface 558 is angled relative to a centerline of the piston 530 and in some embodiments may be angled at approximately 30 degrees relative to the centerline. In one example, the lip 560 has a length of approximately 0.07 inches and the beveled surface 558 has a length of approximately 0.03 inches. However, many other dimensions are anticipated and the above are merely examples. The beveled surface 558 helps reduce frictional engagement of the piston 530 within the bore of the pump body 536. For example, the angled edges of the beveled surface 558 allow some non-linear movement of the piston within the chamber 536, while still preventing the piston from engaging or catching on the interior walls 534 of the pump chamber 536. The angle of the bevel may be selected based on an expected motion range of the connecting rod 506 and help account for any non-linear motion transmitted from the connecting rod 506 to the piston 530.

The end cap 556 defines a pushing surface that exerts a force on the fluid within the pump chamber 536. The end cap 556 may be defined as desired but generally may be a flat close planar surface 556 that is sufficient to exert a pressure force on fluid within the pump chamber.

The sealing member 532 will now be discussed in more detail. FIG. 16 is a front elevation view of the sealing member 532. With reference to FIG. 14A, 14B, and 16, the sealing member 532 may be formed as a generally ring shaped deformable member and includes a sealing body 562 having a first edge 576 and a second edge 568. Sealing protrusions, such as first and second seal ridges 564, 566 extend outwards from the top surface of the seal body 563. For example, the seal body 563 may have a diameter or width W2 and the seal ridges 564, 566 may have a diameter or width W3 that is larger than width W2. In particular, the seal ridges 564, 566 may have a height H1 above the top surface of the seal body 563. The height H1 is selected to allow the ridges 564, 566 to compress and deflect, during movement. Example dimensions for the seal member include width W3 (largest width including the ridges) is 0.319 inches, the overall length L7 of the entire sealing member may be 0.114 inches, and an interior diameter width W4 may be 0.197 inches.

In one embodiment, the seal ridges 564, 566 extend around the entire outer surface of the seal body 563 and are arranged to so as to be parallel to one another. The seal ridges 564, 566 may be spaced apart from one another, such as by a gap 568. The gap 568 may have a length L2 that is the same or longer than the lengths L3 and L4 of the ridges 564, 566. Additionally, the seal body 563 may form the edges 576, 578 on the opposite side of the ridges from the gap 568. The edges 576, 578 may have lengths L5, L6 that are substantially equal to each other and may be less than or the same as the length L2 of the gap 568.

With reference to FIG. 14b, in some embodiments, the sealing member 532 may also include interior ridges 572, 574 that extend inwards from an interior surface 570 of the seal body 563. The interior edges 572, 574 help to engage the sealing member 532 with the piston 530 as the interior edges may act to grip or increase the frictional coefficient of between the sealing member 532 and the outer surface of the piston 530. In some embodiments, the interior edges 572, 574 are substantially aligned with the exterior ridges 564, 566 but on the interior surface. Additionally, in some instances the interior ridges 572, 574 may have a curvature radius that is smaller than a curvature radius of the exterior ridges 564, 566. Similarly to the exterior ridges, the interior ridges 572, 574 may extend as annular protrusions form the seal body 563 but extend inwards towards a center axis of the sealing member 532.

It should be noted that although parallel ridges 564, 566, 572, 574 are shown, the frictional protrusions may be defined in other manners, such as raised bumps or discrete features, multiple parallel lines closely spaced together, and so on. Other examples include a quad ring structure where the ridges form an “X” shape in cross-section and are formed at the edges of the sealing member, rather than positioned away from the edge walls as shown in FIG. 16.

The shape and material of the sealing member 532 is selected to be compressible, fluid-tight, and also low friction to avoid introducing drag into the pump assembly 500 during operation. In some embodiments, the sealing member 532 may be urethane rubber, silicone, or ethylene propylene diene terpolymer (EPDM). Additionally, the sealing member 532 material may include one or more additives or coatings that enhance the frictional characteristics (e.g., reduce a friction coefficient) or increase the fluid-sealing characteristics. The sealing member 532 may have a shore rating between 60+/−5 Shore A to 70 +/−5 Shore A. Specific examples in urethane rubber 65 +/−5 Shower A, silicone 70 +/−5 Shore A, silicone with internal low friction additive 70 +/−5 Shore A, silicone with internal low friction coating 70 +/−5 Shore A, and/or EPDM 60 +/−5 Shore A with a low friction coating. Examples of additives or coatings that may be used include polytetrafluoroethylene, tetrafluoroethylene, hexafluorpropene, fluorinated ethylene propylene copolymer, perfluoro(methylvinylether), perfluoro(propylvinylether), ethylene tetrafluoroethylene, and polymers and copolymers thereof, as well as similar types of materials or chemicals.

With reference to FIG. 14A, to assemble the force exerting assembly 504, the sealing member 532 is positioned over the end cap 556, slid over the beveled surface 558 and the lip 560 and positioned within the sealing recess 554. The angle of the beveled surface 558 may assist in positioning the sealing member 532, by allowing the sealing member 532 to more slowly deform to accommodate the increase diameter of the lip 560. After the sealing member 532 is aligned with the sealing recess 554, the deformation force (such as a stretching force) exerted on the sealing member 532 is removed. The sealing member 532 then returns to an original configuration and is secured in the sealing recess 554 by the terminal edge of the main body 540 and lip 560, which have substantially the same diameter as the interior diameter width W4 of the interior surface 570 of the sealing member 532.

With referenced to FIG. 14B, the sealing member 532 is arranged in the sealing recess 554 such that the interior ridges 572, 574 engage the outer surface of the outer surface of the sealing recess 554. The interior ridges 572, 574 grip the outer surface to ensure that the sealing member 532 moves with the movement of the piston 530, and also help to ensure that the sealing member 532 remains in the desired position in the sealing recess 554. In embodiments where the interior ridges 572, 574 include a large or sloping curvature radius, the additional surface area of the material contacting the outer surface of the sealing recess 554 further assists in ensuring that the sealing member 532 remains in the desired position. In the assembled configurator the end cap 556 may extend past the sealing member 532. In some embodiments, the piston 530 is a harder material, e.g., plastic, as compared to the sealing member 532, and this configuration alloys the harder end cap 556 to exert a stronger force on the fluid. In other words, the end cap 556 is more rigid than the sealing member material and may exert a more uniform and stronger force on the fluid within the pump chamber than if the sealing member covered the end of the piston.

Once the piston assembly 540 is secured together, the piston assembly 504 is connected to the connecting rod 506. With reference to FIGS. 13C and 13D, the ball end connecting cavity 546 and inserted into the ball cavity 548 of the piston 530. In some embodiments, the connecting end 528 is frictionally fit into the ball cavity 548 (e.g., press fit), but in other embodiments, the connecting end 528 may be secured in other manners (e.g., adhesive or the like). The arm 526 of the connecting rod 506 extends out of the piston 530 through the connecting cavity 546. The cam follower 524 of the connecting rod 506 can then be connected to a drive assembly, such as an eccentric cam, on a gear connected to a motor.

With reference to FIGS. 13C and 13D, the piston assembly 504, with the connected connecting rod 506, is inserted into the pump chamber 536 via the open end 538 of the pump body 508. In particular, the connecting end 528 of the connecting rod 506 is inserted into connecting cavity 546 and inserted into the ball cavity 548 of the piston 530. In some embodiments, the connecting end 528 is frictionally fit into the ball cavity 548 (e.g., press fit), but in other embodiments, the connecting end 528 may be secured in other manners (e.g., adhesive or the like). The piston assembly 504 is oriented in the pump chamber 536 such that the end cap 556 is position adjacent the body lumen 562 and end wall 535 and the terminal edge 548 of the main body 540 is aligned with or extends past the open end 538 of the pump body 508. The pump assembly 500 is then connected to the oral irrigator 100, 200 in conventional manners to fluidly connect the reservoir and the tip to the pump inlet 510 and pump outlet 516, respectively.

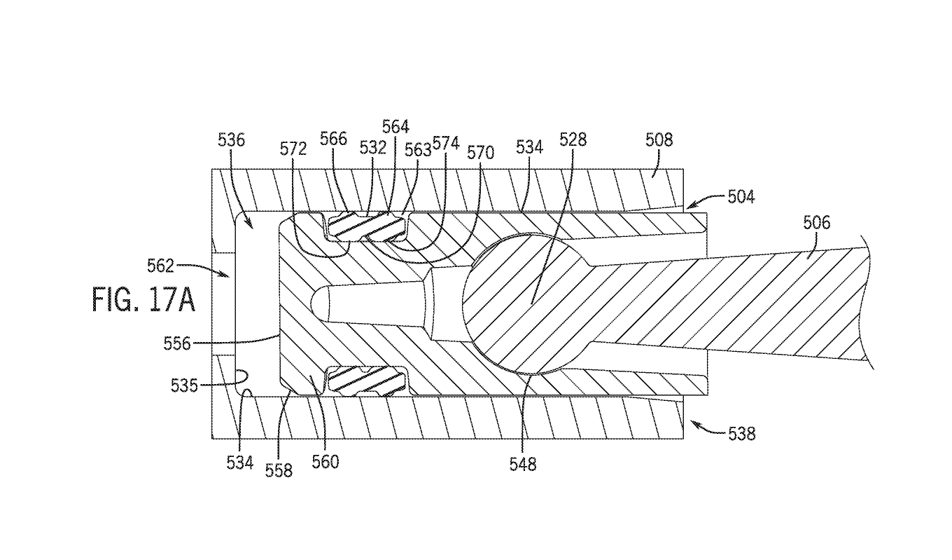

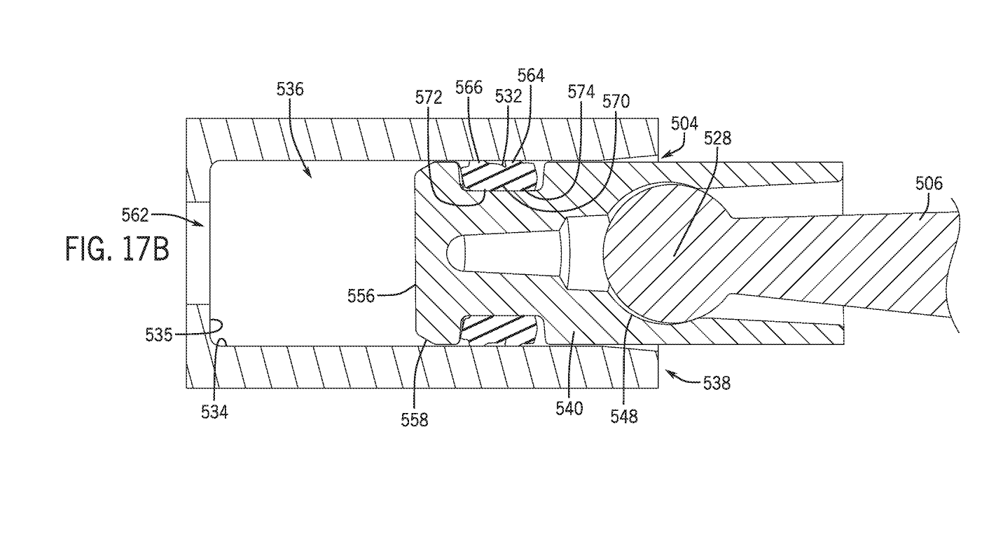

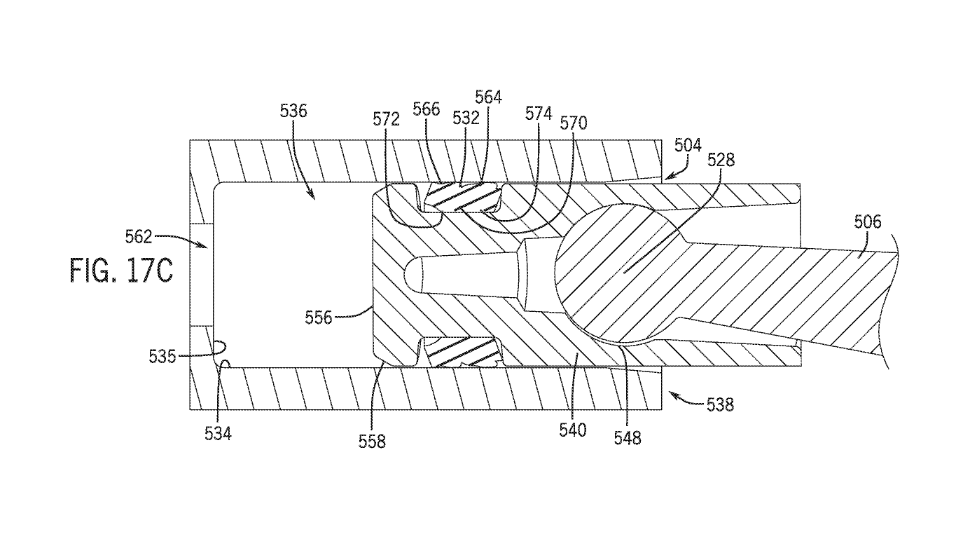

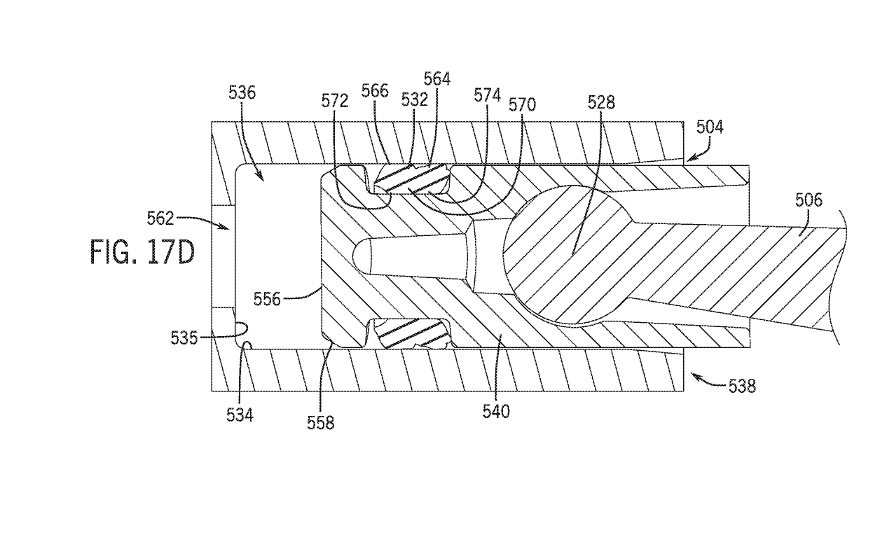

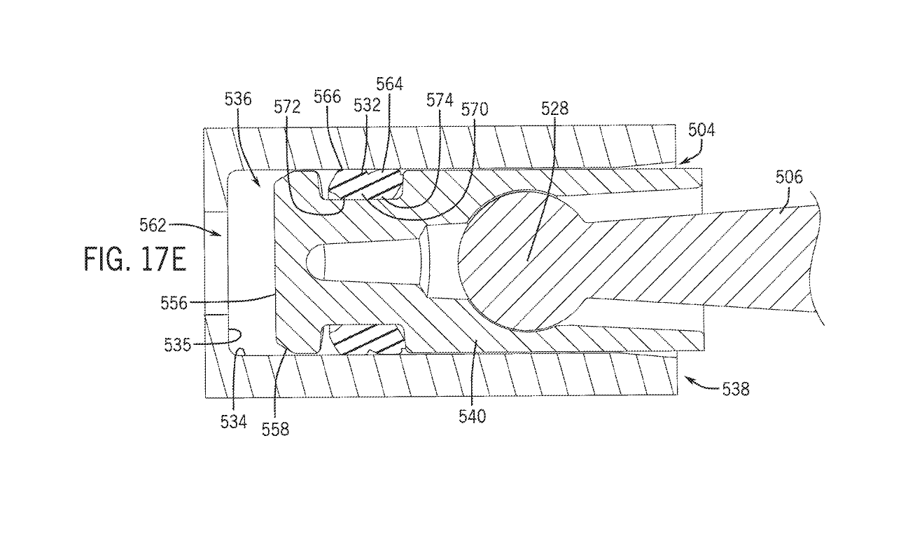

FIGS. 17A-17E are enlarged cross-sections of the pump assembly illustrating the piston assembly in different positions within the pump body. With reference to FIGS. 17A-17E, operation of the force exerting assembly 504 and the pump assembly 500 will now be discussed in more detail. The motor and drive assembly cause the connecting rod 506 to move generally linearly away from the pump housing 502 (e.g., a downward stroke) from an initial or neutral position. As shown in FIG. 17A, this movement, causes the force exerting assembly 504 to move from a first position adjacent to the end wall 535 of the pump chamber 536 towards a second position near the open end 538 of the pump chamber 536. As the force is initially applied, the sealing member 532 beings to deform with the sealing ridges 564, 566 engaging the interior wall 534 at two locations to define two contact points for the piston assembly 504 with the pump body 508.

With reference to FIG. 17B, as the connecting arm 506 rotates to a different position, the connecting end 528 of the rod 506 rotates slightly within the ball chamber 548, causing the arm 526 to be become somewhat aligned with a centerline of the piston body 530. This causes the piston 530, which is constrained by the pump body 508 to continue to move away from the end wall 535 of the pump chamber 536 towards the open end 538. During this down stroke, the sealing member 532, and specifically the ridges 564, 566, engage the interior wall 534 to define a seal, fluidly sealing the open end 538 of the pump body 508 from the pump chamber 536. This seal helps to increase the vacuum or suction force created by the pump movement. This force, pulls fluid into the outlet 510 from the reservoir 104, which then flows into the body lumen 562 and into the pump chamber 536.

As shown in FIG. 17B, at the bottom of the down stroke, the piston chamber 536 is at maximum capacity and available to receive fluid from the pump outlet 510. The suction created by the engagement of the sealing member 532 at two locations on the interior wall 534, allows from a strong vacuum force, pulling in a maximum amount of fluid quickly. Conventional pistons for oral irrigators are not typically configured to create tight seals during the suction or downward strokes in the pump. This reduces the overall force exerted on the fluid and may reduce the amount of fluid that can be pulled into the pump chamber at any given time.

With reference to FIG. 17C, when the connecting rod 506 has reached the movement end for the downward stroke, the connecting rod 506 is moved by the drive assembly to transition to a push stroke. As shown in FIG. 17C, this causes the connecting end 528 of the connecting rod 506 to pivot within the ball cavity 548. The piston 530 is constrained within the pump chamber 536 due to the interior wall 534 and the cylindrical shape of the piston body 530 helps to maintain the piston in a relatively centered orientation within the pump body 508. As the connecting rod 506 moves, the piston assembly 504 moves in the opposite direction within the pump chamber 536, i.e., towards the end wall 535 and body lumen 562 and away from the open end 538 of the pump body 508. With this additional force, the sealing member 532 further compresses and deforms against the interior wall 534 of the pump body 508. Due to the high forces, the interior surface 570 of the sealing member 532 begins to be pulled away from the outer surface of the piston 530, but the interior sealing ridges 572, 574, with the additional material, continue to grip against the piston body 530, helping the sealing member 532 remain in position.

With reference to FIGS. 17D and 17E, as the piston continues its transition within the pump chamber 536 towards the end wall 535, the sealing member 532 and specifically the ridges 564, 566 continue to compress and deform to engage the interior wall 534 at two locations (e.g., both contact points of the ridges 564, 566) and prevent fluid from escaping around the edges of the piston assembly 504 to exit the open end 538 of the pump body 508. The end cap 556 compresses the fluid and exerts a force on the fluid within the pump chamber 536. Because the sealing member 532 creates a fluid tight seal, the fluid cannot escape around the piston assembly 504 and is forced out of the pump chamber 536 through the body lumen 562. The fluid may then be directed into the pump outlet 516 and into the tip of the oral irrigator. As noted above, in some embodiments a pressure regulator may be used and in these instances, some of the fluid exiting the body lumen 562 at each stroke of the pump may enter into the regulator inlet 518 and return back to the pump outlet 510 and/or reservoir via the regulator outlet 520.

In many embodiments the sealing member 532 is configured to engage the interior walls 534, but due to the contact surface areas be limited to the ridges 564, 566, rather than the entire sealing member outer surface, the average coefficient of friction between the interior wall 534 and the sealing member 532 is reduced. In instances where the sealing member 532 may include a low friction additive or coating, this further reduces the friction generated between the two surfaces. The low friction allows the piston assembly 504 to reciprocate within the pump chamber 532 freely and without exerting drag or introducing inefficiencies into the pump assembly 500 that could require additional power, slow down the movement, or reduce the pumping frequency or pressure.

Further, the dual-seal feature of the sealing member 532 that allows sealing both on the suction and compression strokes of the pump, allows the prime-time for the pump 500 to be reduced as compared to conventional oral irrigator pumps. In other words, the pump assembly 500 may begin pumping fluid almost instantly when the motor is activated, even in instances where the pump 500 may not have been activated in a while and there is not currently fluid within the pump chamber 536 and pump housing 502.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. An oral irrigation device comprising:
a reservoir for storing fluid;
a tip fluidly connected to the reservoir; and
a pump operative to draw the fluid from the reservoir and propel the fluid to the tip, the pump comprising:
a pump body having an interior wall defining a pump chamber in fluid communication with the reservoir and the tip, the pump chamber terminating in an open end;
a force exerting assembly received within the pump chamber of the pump body and moveable in a reciprocating motion between a first position and a second position, the force exerting assembly comprising:
a force exerting member; and
a compressible sealing member received around the force exerting member, wherein the sealing member engages the interior wall of the pump body during movement from the first position to the second position and movement from the second position to the first position to prevent fluids from escaping from the open end of the pump body.

2. The oral irrigation device of claim 1, wherein the force exerting member comprises:
a top end; and
a body portion extending from the top end, wherein the body portion has a constant width along an entire length thereof.

3. The oral irrigation device of claim 2, wherein the top end of the force exerting member comprises a sealing recess, wherein the sealing member is received within the sealing recess.

4. The oral irrigation device of claim 2, wherein the top end comprises a beveled exterior edge that transitions to a lip, wherein the lip surrounds a perimeter of the sealing recess.

5. The oral irrigation of claim 4, wherein the beveled edge has an angle of approximately 30 degrees relative to a center line of the body portion.

6. The oral irrigation device of claim 1, wherein the sealing member comprises:
a seal body;
a first contact extending outwards from an outer surface of the seal body by a first height; and
a second contact extending outwards from the outer surface of the seal body by the first height.

7. The oral irrigation device of claim 6, wherein the sealing member further comprises:
a third contact extending inwards from an interior surface of the seal body; and
a fourth contact extending inwards from the interior surface of the seal body.

8. The oral irrigation device of claim 7, wherein the third contact and fourth contact are substantially aligned with the first contact and the second contact, respectively.

9. The oral irrigation device of claim 8, wherein
the first contact and the second contact have a first curvature radius; and
the third contact and the fourth contact have a second curvature radius that is larger than the first curvature radius.

10. The oral irrigation device of claim 7, wherein the third and fourth contact define engagement locations for the sealing member on the force exerting member.

11. The oral irrigation device of claim 1, wherein the sealing member defines two sealing points against the interior wall in two directions.

12. The oral irrigation device of claim 11, wherein the sealing member comprises:
a first ridge; and
a second ridge spaced apart from the first ridge, wherein the first and second ridges engage the interior wall.

13. The oral irrigation device of claim 12, wherein each the first ridge and the second ridge define a fluid tight seal with the interior wall.

14. The oral irrigation device of claim 12, further comprising a spacing gap defined between the first ridge and the second ridge.

15. The oral irrigation device of claim 1, wherein the force exerting member further comprises a sealing recess and the sealing member is received within the sealing recess.

16. The oral irrigation device of claim 15, wherein the sealing recess is spatially separated from a top end of the force exerting assembly.

17. The oral irrigation device of claim 16, wherein the force exerting member further comprises two edges

18. A pump assembly for an oral irrigator comprising:
a pump housing comprising:
a pump inlet in fluid communication with a fluid reservoir;
a pump outlet in fluid communication with the pump inlet and a tip for the oral irrigator; and
a pump body including an interior surface defining a pump bore, the pump bore positioned between and in fluid communication with the pump inlet and the pump outlet; and
a piston assembly operably connected to the pump housing and movable relative thereto, the piston assembly comprising:
a piston comprising:
an end cap;
a skirt extending from the end cap; and
a sealing groove positioned between the end cap and the skirt, wherein the sealing groove is recessed below an outer surface of the skirt and an outer surface of the end cap; and
a dual-direction seal positioned within the sealing groove, wherein the dual-direction seal engages the interior wall to define one or more fluid seals when the piston moves in a first direction within the bore and when the piston moves in a second direction in the bore.

19. The pump assembly of claim 18, wherein dual-direction seal comprises a first sealing ridge and a second sealing ridge spaced apart from one another.

20. The pump assembly of claim 19, wherein the first sealing ridge and the second sealing ridge have a first width that is larger than a width of the skirt of the piston.
